(19) United States
(12) Patent Application Publication
(10) Pub. No.: US 2005/0251558 A1
(43) Pub. Date: Nov. 10, 2005

(54) Remote reminders application system

(76) Inventor: Karim Moheb Zaki, Toronto (CA)

Correspondence Address: Karim Moheb Zaki, 75 Meachin Dr., Dunsford, ON, K0M 1L0, CA

(21) Appl. No.: 10/919,358

(22) Filed: Aug. 17, 2004

Related U.S. Application Data
(60) Provisional application No. 60/495,881, filed on Aug. 19, 2003.

(51) Int. Cl. H04M 11/00; G06F 15/16

(52) U.S. Cl. 709/206

(57) ABSTRACT

Systems, methods and computer program operating on a computer that integrates as an add-on with software based day/time planners and calendars then notifies the users using speech synthesis by telephone (mobile or landline) of reminders and appointments at the appropriate date and time based on what the users have preset and registered as upcoming reminders (reoccurring or not). Sending a facsimile, text messaging on a mobile telephone or a hand-held organizer (using SMS), voice synthesis on loudspeakers, text pager, PDA, or emailing reminders in text or HTML format could also achieve the notification or any combination of these methods. Equally, the system could allow the users to dial-in, using either voice commands by performing speech recognition or accepting dial tones when the users press the telephone's keypad and performing commands to check for upcoming reminders, add, delete or edit reminders as well as direct the system as to how it should deliver back its responses and reminders. Alternately, the users may electronically send the system emails with embedded commands, to which the system may periodically check for, in order to allow the same kind of remote control.

### BACKGROUND OF THE INVENTION

1. Field of the Invention

The present invention relates to a computer system, and deals more particularly with methods, systems, and computer program products for notifying users using speech synthesis by telephone (mobile or landline), email, fax or text messaging on portable devices such as PDAs, Pagers, Mobile phones or any remote computer system of reminders and appointments at the appropriate date and time based on what the users have preset and registered as upcoming reminders (reoccurring or not).

2. Description of the Related Art

Electronic calendars or computerized day/time planners systems are quite popular among computer users, both in business settings and for personal use. Electronic calendars in many cases contain a wealth of information about their owner. For example, an individual may use an electronic calendar to maintain information about his work schedule, his meetings and other appointments, his vacations and business travel plans (including when he will be away, which flights or other transportation he will use, where he can be reached while away, who he may visit while away, etc.), phone calls that need to be made at particular times, and so forth. Examples of electronic calendaring systems include Microsoft Outlook.RTM. 2000 and Lotus Organizer.RTM., which also allows a user to create entries on his calendar for other people. For example, a secretary might have calendar entries for his own schedule, but also keep information about his manager's appointments on his own calendar as well. (“Outlook” is a registered trademark of Microsoft Corporation, and “Lotus Organizer” is a registered trademark of Lotus Development Corporation.)

Moreover, connectivity of people has grown dramatically in the last few years due to the exponential popularity of mobile phones, PDAs, faxes, pagers and of electronic mail over the Internet, or “e-mail”, enabled systems.

However, there have been so far very little attempts to combine those two trends into one functional invention. In these prior art messaging systems, computerized day/time planners would notify users of reminders with an on-screen popup text message that might at best be accompanied by a simple sound or beep to attract the users' attention. The users would have to go to the computer and read off the monitor the content of the reminder after longing on or deactivating the screen saver, if one was present.

U.S. Pat. No. 3,001,8724, which is entitled “Time-sensitive messages and events” discloses a technique to convey time-sensitive messages and events (such as electronic mail messages, electronic calendar entries, and “to-do” items), and for handling such messages and events at the receiver's end. A message sender marks messages as to whether they are time-sensitive, and may also identify a starting and ending time and/or date during which the time-sensitive status applies. When such a message arrives at a recipient, it is evaluated and if the time-sensitive period has been reached, the message is automatically displayed to the recipient. The main concern in this art was the prioritizing of events and the enforcing of some kind of a response back or acknowledgement to the sender. While the technique presented herein is concerned with the delivery of the reminders remotely to users when they are in the vicinity of their computer operating their day/time systems or even away on the road.

Accordingly, improved techniques are needed which avoid the limitations of prior art systems.

### SUMMARY OF THE INVENTION

According to one broad aspect of the present invention that it provides improved techniques for delivering time-sensitive messages and events.

Another aspect of the present invention is to provide a technique which enables a message or reminder be delivered remotely to the recipient.

It is a further aspect of the present invention to provide an automated follow-up mechanism for time-sensitive messages and events.

Yet another aspect of the present invention is to enable message and event recipients and sender to manage, add, edit, alter, reschedule and delete messages remotely.

Yet another aspect of the present invention is to enable message and event recipient and sender to forward messages to other recipients with the possibility rescheduling them.

Still another aspect of the present invention is to enable the message recipient to have control if he would like to “snooze” a reminder for a certain amount of time and to be re-reminded of it later in the same manner or a multitude of other methods of message delivery.

In accordance with an aspect of the invention as broadly described herein, in a first aspect the present invention provides methods, systems, and computer program products for delivering time-sensitive messages, reminders and events. This technique comprises: sending the message to the recipient; and automatically receiving a reply from the recipient regarding the sent message within a time period of the time-sensitivity of the sent message. The marking may optionally indicate whether snoozing is allowed by the recipient for this message. The marking may indicate an ending time for the time period of the time-sensitivity of the message, and may also indicate a starting time for the time period.

The technique may further comprise: receiving the marked message at a computing device of the recipient; determining whether the time period of the time-sensitivity of the received message has been reached; and requiring the received message to be rendered to the recipient if so. In this case, the recipient may be required to respond to the rendered message.

The required rendering may be delayed until a later time if snoozing is allowed for the selected one, provided the recipient defines the length of the snoozing either as a preset value or at the time of receiving the notification.

The electronic messages may be, for example, e-mail messages, electronic calendar events, facsimile, SMS message, phone call, announcement on the computer's speakers, or to-do items.

The present invention will now be described with reference to the following drawings, in which like reference numbers denote the same element throughout.

### BRIEF DESCRIPTION OF THE DRAWINGS

FIG. 1 illustrates the various combinations of connections and interfacing the system could potentially have for reminders delivery.

FIG. 2 illustrates the various combinations of connections and interfacing the system could potentially have for reminders query, update and maintenance.

FIG. 3 in addition to summarizing FIG. 1 and FIG. 2 in a textual format, it also shows the relationship the system may has with the computerized day/time planners and how the control may flows between all of them.

FIG. 4 demonstrates the preferred hierarchical layers and their relationships.

FIG. 5 illustrates in a schematic form how the various system modules may interact and how their inner logic may follow.

### DESCRIPTION OF PREFERRED EMBODIMENTS

For the invention to be useful to users, it may interface with the telephone system (landline or mobile telephones) as well as to the Internet in order to be able to notify the users (by phone, fax, email, pager or text messaging) of their reminders. Furthermore, through the telephone system (again, landline or mobile telephones) as well as Internet, it could allow the users to call-in or send embedded commands to query, manipulate, update and maintain the upcoming events as well as control the various functions of the system itself.

The invention at hand could eliminate the need to read off the monitor the reminders, as they could be announced on the computer's speakers by synthesizing the text of the reminder as it pops up on the computer screen. Furthermore, if the users leave their home or work location and are away from their computers that are operating the computerized day/time planners, they could still remotely receive those reminders using speech synthesis over the telephone (mobile or landline) or textually by email, fax or text messaging on portable devices such as PDAs, Pagers, or SMS enabled Mobile phones or PDAs.

Therefore, the present invention teaches a method for extending the reach of such computerized day/time planners and gives them the ability to “deliver” users' notifications of upcoming events and reminders as they happen in a real-time fashion by telephone, facsimile, text messaging or email or any combination thereof. Moreover, the present invention could allow a multitude of individuals to be notified of such events. Furthermore, it allows users to control, query, update and maintain such notifications remotely.

Some possible real life implementations and usage examples of users receiving reminders by speech synthesis over the telephone (mobile or landline) or textually by email, fax or text messaging on portable devices such as PDAs, Pagers, or SMS enabled Mobile phones or PDAs may be:
a. A sales person on the road being remotely reminded by the system of calls to make and follow-ups on leads.
b. A doctor or lawyer's office reminding patients or clients of their upcoming appointments.
c. An individual being reminded of personal appointments, things to do or business meetings.
d. Having the system automatically sending birthday greetings to family members and friends on the appropriate date with the appropriate message.
e. The system speaking out loud to remind the user of television shows that are of interest and eliminating the need to go all the way to the computer to read such notifications.
f. Users calling in into the system using speech synthesis or dial tone commands to check for upcoming reminders or to-do list and managing them.
g. Users sending email messages with embedded commands to the system to check for upcoming reminders or to-do list and managing them.
h. Users calling in into the system and recoding with their own voice a reminder or a to-do item which may be delivered back—still in their own voice—at the appropriate date and time by phone or as an attached sound file in an email message.

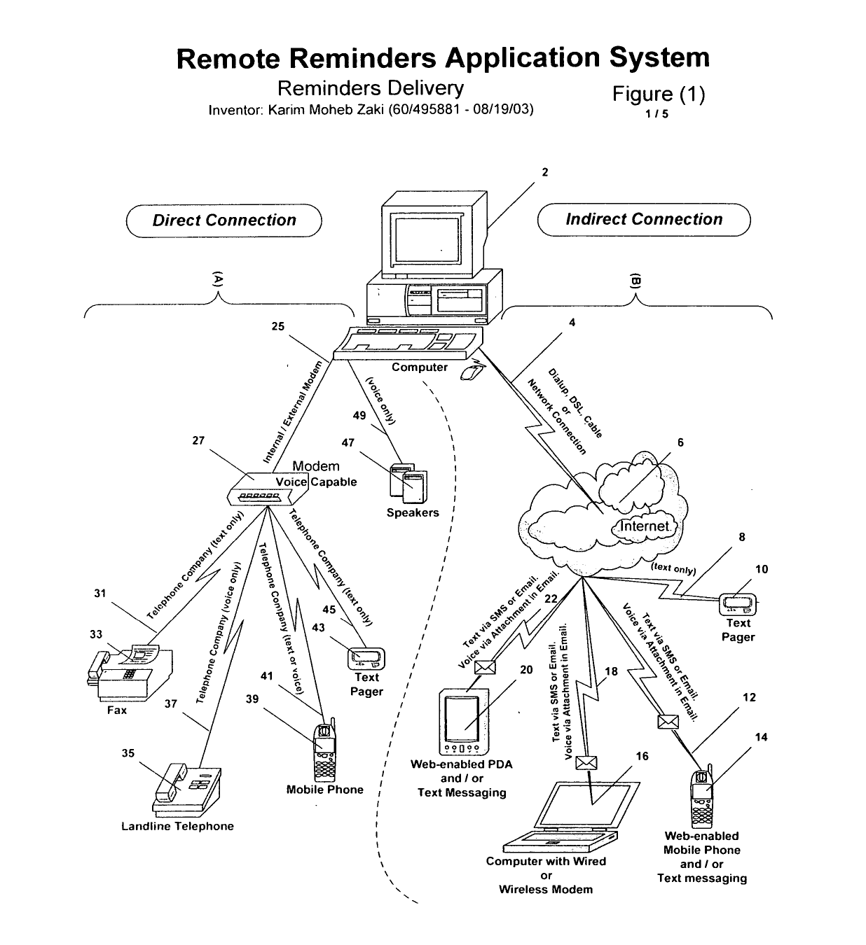

FIG. 1 demonstrates the various options the system may have to deliver reminders to users aside through the basic text message on the screen traditionally provided by the computerized day/time planners as the only way of delivering reminders. The first approach could be through a “Direct Connection” (item A) with two main sub approaches: —1—from the computer straight to the loudspeakers of the computer (items 47 & 49) by synthesizing the text of the reminder—2—through a voice capable modem (item 27) connected (item 25) internally or externally to the computer (item 2), the system may dial-out through the telephone company network (items 31, 37, 41 & 45)—all of these configurations, as well as the appropriate communications hardware and software, are known in the art—and deliver the contents of the reminder to the users as:
a. Text to a fax number (item 33).
b. Voice call by synthesizing the text of the reminder on a landline (item 35).
c. Voice call by synthesizing the text of the reminder on a mobile line (item 39).
d. Text to a text capable pager number (item 43).
   Likewise, if the system has access to the Internet—either though dialup, DSL, cable or a network connection or any other means (items 4, 6, 22, 18, 12 & 8), it may have an “Indirect Connection” (item B) and deliver the reminder to the users as:
a. Text to a web-enabled PDA (item 20) in an email message or the synthesized text message to a voice message as an attachment to an email message.
b. Text to a computer (item 16) in an email message or the synthesized text message to a voice message as an attachment to an email message.
c. Text to a web-enabled mobile telephone (item 14) in an email message, a SMS, or the synthesized text message to a voice message as an attachment to an email message.
d. Text to a text capable pager number (item 10).

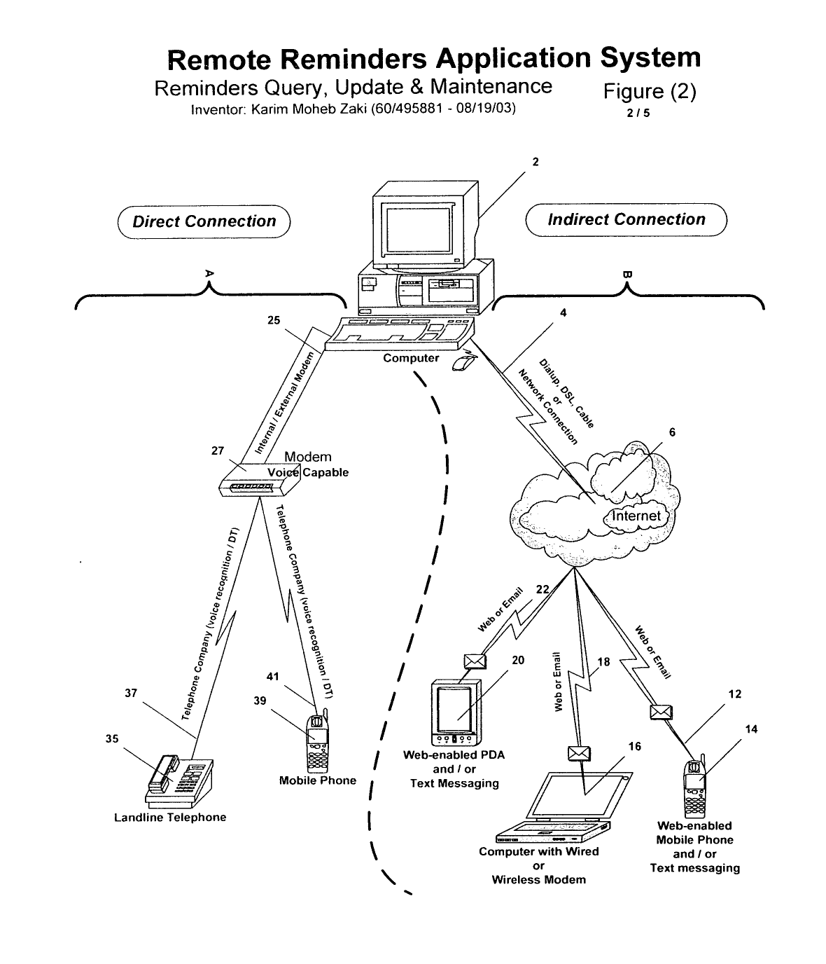

FIG. 2 shows the various options the system may provide users to remotely query, control and manipulate (add, edit or delete) reminders in their computerized day/time planner: —1—the first approach could be through a “Direct Connection” (item A). Through a voice capable modem (item 27) connected (item 25) internally or externally to the computer (item 2), the users may dial into the system through the telephone company network (items 37 & 41) and obtain control over the system through:
a. Voice call by speech recognition or dial tone commands over a landline (item 35).
b. Voice call by speech recognition or dial tone commands over a mobile line (item 39). —2—likewise, if the system has access to the Internet—either though dialup, DSL, cable or a network connection (items 4, 6, 22, 18 & 12)—it may have an “Indirect Connection” (item B) and allow the users to remotely query, control and manipulate (add, delete or edit) reminders in their computerized day/time planner through text commands delivered to:
a. a web-enabled PDA (item 20) in an email message.
b. a computer (item 16) in an email.
c. a web-enabled mobile telephone (item 14) in an email message.

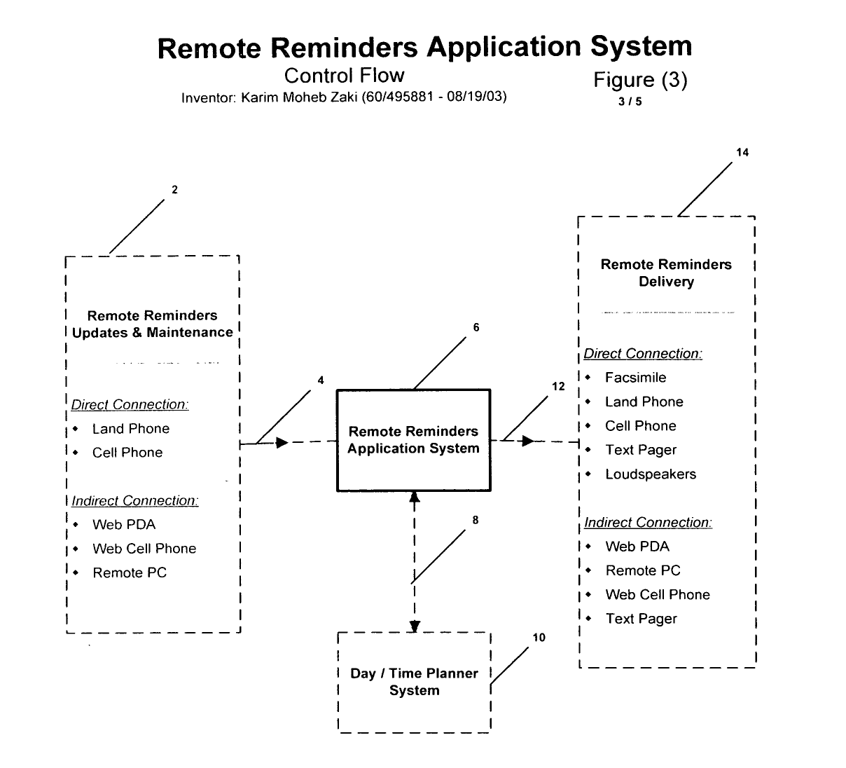

FIG. 3 shows how the Remote Reminders Application System (item 6) could be the entity that receives the users' queries, updates and maintenance requests for the upcoming events from the users coming from the various methods described in the Remote Reminders Updates & Maintenance module (item 2) through the various connectivity methods (item 4)—whether Direct or Indirect Connections as described above in FIG. (2). Then it passes those requests and commands to the Day/Time Planner System module (item 10) internally operating on the computer (item 8)—both modules of item 6 and item 10 may be operating on the same or different computers. Furthermore, item 6 could send out the appropriate reminders at the appropriate day and time to the users as defined by the Remote Reminders Delivery module (item 14) through the various connectivity methods (item 12)—whether Direct or Indirect Connections as described above in FIG. (1).

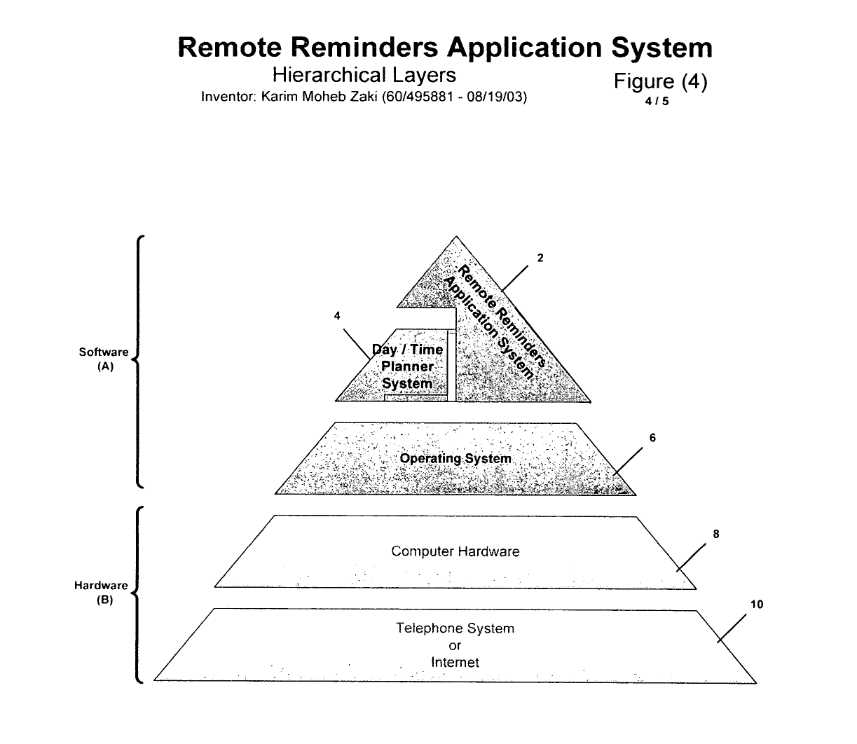

FIG. 4 shows the hierarchical layers, which are divided into two main categories:
a. Software (item A) which is compromised of the following:
   i. Remote Reminders Application System (item 2) sitting at the top and acting at the highest level by receiving users' requests and passing them on downwards to the Day/Time Planner Software (item 4) or deciding when it is due time to perform a user notification by controlling the Operating System (item 6).
   ii. The Day/Time Planner Software (item 4) is where the reminders are stored. In its turn, it could still control item 6 to provide users with text reminders on screen.
   iii. The Operating System (item 6) and directing it to send and receive communications with the users trough the computer's hardware (item 8) that could typically comprise of the modem to dial out, receive phone calls and/or the connecting to the Internet and all other components normally found in a computer.
b. Hardware (item B) which is compromised of the following:
   i. The Computer Hardware (item 8) comprising of all the various components that make up the computer such as the CPU, hard disk, memory, etc.
   ii. Finally the Telephone System or Internet (item 10) could be the black boxes through which the final step of communication with the tool or gadget through which the users could receive their reminders or send their queries and updates for their reminders.

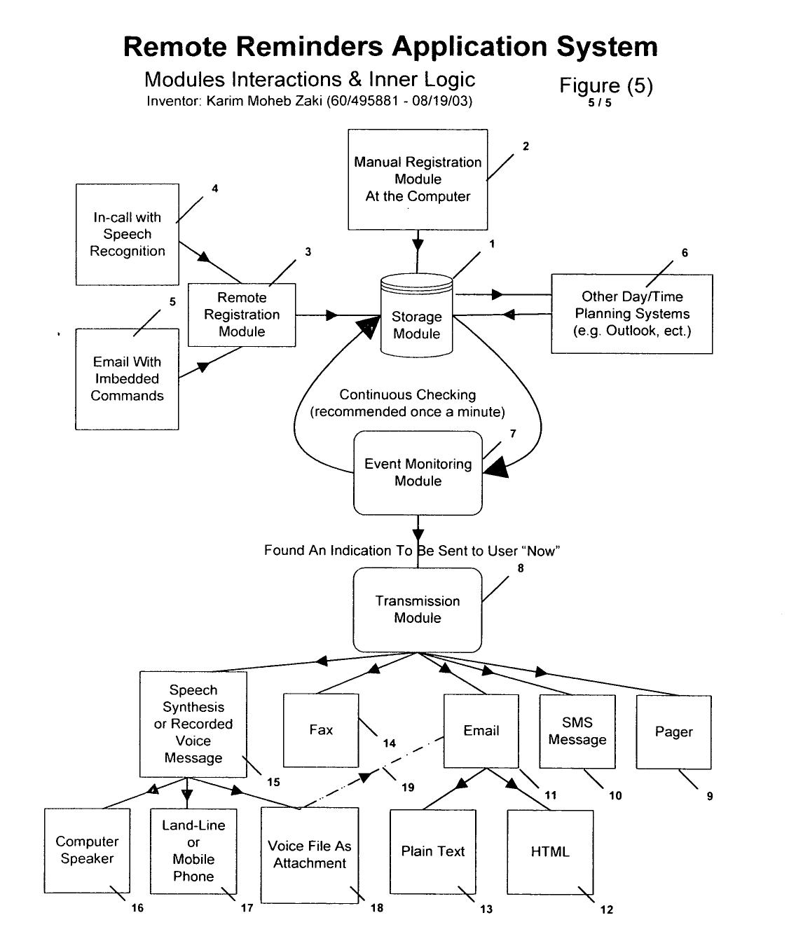

FIG. 5 illustrates in a schematic form how the various system modules may interact and how their inner logic may follow. At the heart of the system is the Storage Module (item 1) that holds in permanent memory—preferably in a database—the reminders, to-do list and all other kinds of indications the user may define. The Storage Module would be added to, deleted from or modified possibly by (these registration methods are not all the possible ones. However, it should be understood that these are only by way of example and to identify the preferred use of the invention known to the inventor at this time. It is believed that there could be many additional methods that will become obvious once one is familiar with the fundamental principles of the invention):
a. Manual Registration Module (item 2) which would be through the user sitting at the computer operating the system—or over a computer network—and using its input devices—such as keyboard, mouse, microphone or any other combination of similar devices.
b. Remote Registration Module (item 3) which would comprise methods to achieve the same in point (a) above but remotely:
   i. the user calling in into the system (item 4) to control and manipulate it through either speech recognition commands or dial tone commands. The system would be continuously monitoring incoming calls to check if the caller is an identified authorized user and starts accepting commands from him.
   j. the user sending to the system email messages with embedded commands (item 5) to achieve the same control over the system. The system would be continuously monitoring incoming emails for messages directed to it for the said purpose.
c. other day/time planning systems (item 6) would also have access to item 1 and would be able to see, manipulate and change the same indications stored in item 1.

The event Monitoring Module (item 7) would be continuously—preferably once every minute—to check if an indication has reached the day and time in which it is supposed to be delivered to the user. Once this condition is met, item 7 would pass the said indication to the Transmission Module (item 8) to determine which format(s) the indication should be converted into to be properly delivered to the user. Item 8 may have the following delivery methods (these delivery methods are not all the possible ones. However, it should be understood that these are only by way of example and to identify the preferred use of the invention known to the inventor at this time. It is believed that there could be many additional methods that will become obvious once one is familiar with the fundamental principles of the invention):
a. Text enabled pager (item 9)
b. SMS enabled equipments (item 10) such as mobile phones, PDAs, Blue Berries or Palm Pilots.
c. Email enabled equipments (item 11) either in plain text format (item 13) or in HTML—Hyper Text Markup Language—format (item 13) such as computers, mobile phones, PDAs, Blue Berries or Palm Pilots.
d. Fax enabled equipments (item 14) such as computers or fax machines.
e. Speech Synthesis or Recorded Voice Message (item 15) as an preparatory initial step before delivering the indication to a voice enabled equipment such as:
   i. Computer speakers (item 16)
   ii. Land Line or Mobile Phone call (item 17)
   iii. Voice File which in turn would be a passed on to item 11 to be attached to an email message and sent to the user who may listen to the notification when opening the file—connection (item 19).
      The Remote Reminders Application System of the present invention allows for many applications. Although reference is made to the embodiments listed above, it should be understood that these are only by way of example and to identify the preferred use of the invention known to the inventor at this time. It is believed that the Remote Reminders Application System has many additional uses that will become obvious once one is familiar with the fundamental principles of the invention.

1. A communication system for forwarding an indication of an event or reminder to a user of one or more devices in communication with the system, the system comprising:
a. Registration module for receiving the indication and receives particulars about the indication;
b. Storage module for retaining the indication and associated particulars;
c. An event-monitoring module for accessing the storage module and monitors for an indication reaching the date and time for delivery. Upon this condition being satisfied, the event-monitoring module determines a delivery method for the indication;
d. A transmission module could be initiate by event-monitoring module for generating a compatible message for the device relating to the indication and initiating transmission of the message to the device.

2. The system of claim 1 combines systems, methods, and a computer software program.

3. The computer software program of claim 1 operates on a computer.

4. The system of claim 3 integrates and shares data with software-based day/time planners and calendars.

5. The system of claim 1, in association with the said software-based day/time planners and calendars of claim 4 are incorporated for the purpose of notifying the user of appointments at the adjustable and may be reoccurring preset date and time.

6. The adjustment of the triggering conditions of an indication of claim 5 are recorded and defined in day/time planner as described in claim 1.

7. The event-monitoring module of claim 1 may trigger a multitude of requests to the transmission module of claim 1 for once single indication to be delivered to variety of devices and communication systems.

8. The selection of which transmission method to be used of claim 7 is recorded along the definition of each indication as described in claim 1.

9. The transmission module of claim 1 could accept from the user a valid identification before delivering the indication.

10. The identification of claim 9 could be in the form of an electronically unique signal sent back to the system from the user through the receiving communication device.

11. The user once receiving an incoming indication from the system he may elect to “snooze” the transmission for a period of time and to indicate electronically back to the system the length of this delay.

12. The user could predefine his preference on the system the length of delay the snoozing of claim 11 may be as in claim 1.

13. When the transmission module of claim 1 fails to deliver an indication it could attempt to repeat the transmission after a predefined delay.

14. The repetition of a failed transmission in claim 12 could be repeated for a predefined number of times as long as that transmission was never successful.

15. The user could predefine on the system the number of transmission attempts the transmission module could try.

16. The system of claim 1 can be utilized in notifying the user of appointments as a stand-alone software program without the use of a software-based day/time planners and calendars in claim 3 by using a built-in day/time planner and calendar.

17. The method used in notifying the user of his/her appointments in the claim 4 and/or the claim 5 is by one or more of the following preset and adjustable means:
a. Text messaging on a mobile telephone.
b. Text messaging on a hand held organizer (PDA).
c. Text messaging on text pager.
d. Sending a facsimile.
e. Sending email to preset address(es) in preset convenient format be it text, or html, or other convenient electronic format.
f. Using text to speech synthesis on a telephone—whether either on a mobile or landline.
g. Using text to speech synthesis on loudspeakers of the personal computer used for the implementation of the system of claim 2.

18. The methods listed of claim 6.a., 6.b., 6.c., 6.d. are in text format.

19. The method listed of claim 6.e. can either be in text, and/or voice file format.

20. The methods listed of claim 6.f. and 6.g. are in voice format.

21. The system of claim 1 allows the user to access and control its functions by any of the following means:
a. User's personal computer of claim 2.
b. Dialing-in using a mobile or land-line and obtaining control by providing:
i. Speech recognition commands.
ii. Dial tones commands by means of the user's telephone keypad.
c. Sending email messages with embedded commands.

22. The method of claim 10.a. could be implemented by utilizing the system of claim 1 or through a computer network or any similar tool that allows remote access to the said computer of claim 2.

23. The method of claim 10.a. can also be implemented by utilizing claim 3, the software-based day/time planners and calendars.

24. The method of claim 10.b. and 10.c. can be implemented by using mobile or landline telephones.

25. The method of claim 10.c. could be periodically checked by the system of claim 1, so as to create the same remote control effect of other said methods 10.a. & 1 0.b.

26. The frequency of periodic checks in the claim 14 could be controlled as preset preferences of the system of claim 1, and can be adjusted by user just like any other function controlled as described of claim 10.

27. The methods of access in claim 10 could be used for the following grounds:
a. Adding reminders.
b. Deleting reminders.
c. Editing reminders.
d. Directing the system and altering its presets, altering the way it should deliver back its responses and reminders.
